(19) United States
(12) Patent Application Publication
(10) Pub. No.: US 2026/0230687 A1
(43) Pub. Date: Aug. 6, 2026

(54) SYSTEM AND METHOD FOR GENERATING A HYPER-STABILIZED COMPOSITE VIDEO FRAME ASSOCIATED WITH A CAPTURING DEVICE

(71) Applicant: SAMSUNG ELECTRONICS CO., LTD., Suwon-si (KR)

(72) Inventor: Ritesh SINGH, Noida (IN)

(73) Assignee: SAMSUNG ELECTRONICS CO., LTD., Suwon-si (KR)

(21) Appl. No.: 19/577,939

(22) Filed: Mar. 25, 2026

Related U.S. Application Data
(63) Continuation of application No. PCT/KR2024/016445, filed on Oct. 25, 2024.

(30) Foreign Application Priority Data
Oct. 27, 2023 (IN) 202311073385

(51) Int. Cl. H04N 21/854; G06N 3/0475; H04N 21/44; H04N 21/462; H04N 21/485

(52) U.S. Cl. CPC H04N 21/854; G06N 3/0475; H04N 21/44016; H04N 21/4621; H04N 21/4854

(57) ABSTRACT

A method generating a hyper-stabilized composite video frame, includes: obtaining a plurality of video frames captured by each camera of a plurality of cameras of an electronic device; detecting field widths of the plurality of cameras and tilt angles of the plurality of cameras; based on the field widths and the tilt angles, determining a plurality of largest central square field of views (LCSFoVs) of the plurality of cameras; based on the plurality of LCSFoVs, determining a retention area with respect to the plurality of video frames; based on the retention area with respect to the plurality of video frames, identifying, in the plurality of video frames, a plurality of video frame fragments corresponding to the retention area; assembling the plurality of video frame fragments to generate a hyper-stabilized composite video frame, and displaying the hyper-stabilized composite video frame via a display of the electronic device.

### CROSS-REFERENCE TO RELATED APPLICATIONS

This application is continuation of International Application No. PCT/KR2024/016445, filed on Oct. 25, 2024, which is based on and claims priority to Indian Patent Application number 202311073385, filed on Oct. 27, 2023, in the Indian Patent Office, the disclosures of which are incorporated by reference herein in their entireties.

### BACKGROUND

### 1. Field

The present disclosure generally relates to electronic devices, and more particularly, to generating a hyper-stabilized composite video frame associated with a capturing device.

### 2. DESCRIPTION OF RELATED ART

With the increasing use of electronic devices, such as smartphones, tablets, personal computers, and similar devices, users are frequently confronted with the desire to capture and store images or video frames of events or objects using their electronic devices. Typically, events or places of interest become apparent or evident to a user unexpectedly with limited time to capture the moment. As such, users may have to quickly deploy their electronic devices in an image or video-capturing mode to ensure such a moment is not missed or wasted.

In the related art, capturing methods typically involve pressing a combination of physical or virtual keys to access the image/video capturing mode. This may lead to capturing blurry images or images that do not capture the object of interest clearly.

Currently, several image stabilization methods are deployed in various devices to improve the quality and clarity of the captured image/video. For example, Optical Image Stabilization (OIS) techniques or Sensor Shift Stabilization (SSS) techniques move the lens and/or sensor with motors and actuators to counter camera shake. The method compensates for pitching and yawing shakes but cannot affect rolling shake. Moreover, the method can only correct small shake angles and works for image stabilization because of limited maximum correction. Furthermore, the method is prone to aging and failure due to moving parts and is expensive to implement.

Another method that is used in the related art includes Digital Image Stabilization (DIS). This method is designed based on the assumption that camera shake results in convolution of the existing frame and works like blur reduction. However, the DIS method has a low precision and suffers from low quality. Moreover, the processing of the captured image or video is not real-time and needs high processing overhead. Furthermore, this method cannot be used to correct high shake angles.

Yet another method of image stabilization utilizes mechanical actuators to counter camera shake. For example, in such systems, the movement of the camera platform is stabilized using motors and actuators to counter the camera shake. However, the use of advanced mechanical actuators makes the implementation expensive. Moreover, the large number of moving components makes the system prone to failure and aging, for instance, failure due to moving parts.

These drawbacks demonstrate the need for an improved method and system for generating a stabilized video frame that enhances user convenience, efficiency, and the ability to capture and store interactive digital content in a seamless manner. Moreover, an innovative solution that addresses the limitations of existing image and/or video stabilization techniques, allowing users to capture, store, and share higher quality images or videos more efficiently on various electronic devices, is therefore desirable.

### SUMMARY

According to an aspect of the disclosure, a method generating a hyper-stabilized composite video frame, includes: obtaining a plurality of video frames captured by each camera of a plurality of cameras of an electronic device; detecting field widths of the plurality of cameras and tilt angles of the plurality of cameras; based on the field widths and the tilt angles, determining a plurality of largest central square field of views (LCSFoVs) of the plurality of cameras; based on the plurality of LCSFoVs, determining a retention area with respect to the plurality of video frames; based on the retention area with respect to the plurality of video frames, identifying, in the plurality of video frames, a plurality of video frame fragments corresponding to the retention area; assembling the plurality of video frame fragments to generate a hyper-stabilized composite video frame, and displaying the hyper-stabilized composite video frame via a display of the electronic device.

According to an aspect of the disclosure, an electronic device includes: a plurality of cameras; at least one processor; a display; and memory storing instructions, wherein the instructions, when executed by the at least one processor individually or collectively, cause the electronic device to: obtain a plurality of video frames captured by each camera of the plurality of cameras; detect field widths of the plurality of cameras and tilt angles of the plurality of cameras; based on the field widths and the tilt angles, determine a plurality of largest central square field of views (LCSFoVs) of the plurality of cameras; based on the plurality of LCSFoVs, determine a retention area with respect to the plurality of video frames; based on the retention area with respect to the plurality of video frames, identifying, in the plurality of video frames, a plurality of video frame fragments corresponding to the retention area; assemble the plurality of video frame fragments to generate a hyper-stabilized composite video frame, and display the hyper-stabilized composite video frame via the display.

According to an aspect of the disclosure, a non-transitory computer-readable storage medium stores one or more programs including computer-executable instructions that, when executed by at least one processor of an electronic device, cause the electronic device to: obtain a plurality of video frames captured by each camera of a plurality of cameras of the electronic device; detect field widths of the plurality of cameras and tilt angles of the plurality of cameras; based on the field widths and the tilt angles, determine a plurality of largest central square field of views (LCSFoVs) of the plurality of cameras; based on the plurality of LCSFoVs, determine a retention area with respect to the plurality of video frames; based on the retention area with respect to the plurality of video frames, identifying, in the plurality of video frames, a plurality of video frame fragments corresponding to the retention area; assemble the plurality of video frame fragments to generate a hyper-stabilized composite video frame, and display the hyper-stabilized composite video frame via a display of the electronic device.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1A is a pictorial diagram depicting fragments of a current frame to be extracted, according to an embodiment of the present disclosure;

FIG. 1B is a pictorial diagram depicting a retention area including the extracted fragments of the current frame, according to an embodiment of the present disclosure;

FIG. 2 is a block diagram illustrating a system for generating a hyper-stabilized composite video frame associated with a capturing device, according to an embodiment of the present disclosure;

FIG. 3 is a pictorial diagram depicting determination of the retention area of the current frame, according to an embodiment of the present disclosure;

FIG. 4 is a block diagram illustrating a method for generating the hyper-stabilized composite video frame associated with the capturing device, according to an embodiment of the present disclosure, and

FIG. 5 is a block diagram illustrating an electronic device in a network environment according to various embodiments.

### DETAILED DESCRIPTION

For the purpose of promoting an understanding of the principles of the disclosure, reference will now be made to the various embodiments and specific language will be used to describe the same. It should be understood at the outset that although illustrative implementations of the embodiments of the present disclosure are illustrated below, the present disclosure may be implemented using any number of techniques, whether currently known or in existence. The present disclosure is not necessarily limited to the illustrative implementations, drawings, and techniques illustrated below, including the example design and implementation illustrated and described herein, but may be modified within the scope of the present disclosure.

Further, skilled artisans will appreciate that elements in the drawings are illustrated for simplicity and may not have necessarily been drawn to scale. For example, the flowcharts illustrate the method in terms of the most prominent steps involved to help improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

It will be understood by those skilled in the art that the foregoing general description and the following detailed description are explanatory of the disclosure and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

It is to be understood that as used herein, terms such as, “includes,” “comprises,” “has,” etc. are intended to mean that the one or more features or elements listed are within the element being defined, but the element is not necessarily limited to the listed features and elements, and that additional features and elements may be within the meaning of the element being defined. In contrast, terms such as, “consisting of” are intended to exclude features and elements that have not been listed.

The embodiments herein and the various features and advantageous details thereof are explained more fully with reference to the non-limiting embodiments that are illustrated in the accompanying drawings and detailed in the following description. Descriptions of well-known components and processing techniques are omitted to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks that carry out a described function or functions. These blocks, which may be referred to herein as units or modules or the like, are physically implemented by analog or digital circuits such as logic gates, integrated circuits, microprocessors, micro-controllers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits constituting a block may be implemented by dedicated hardware, by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

Existing video stabilization methods using a central rectangular field of view of the wide angle camera generate video frames of low resolution with reduced low light performance and less than optimal field of view. Everything outside the recorded rectangle is wasted sensor space resulting in low resolution and bad low light performance. Although, these drawbacks may be overcome by using multiple cameras to switch between them depending on the magnitude of camera shake, only one camera is active at a time. This can lead to the quality of the captured video frame being non-uniform since in practice even large camera shakes are usually interspersed with smaller ones (for example while recording from a moving vehicle). Moreover, for large camera shake angles, the video/image resolution and low light performance degrade significantly because of the use of only the central portion of a wide angle camera. Additionally, the algorithm needs additional complications to manage the camera switch smoothly. This includes starting the next camera before shutting off the current camera, and having a buffer angle zone where the optimal camera is not selected to avoid rapid back and forth camera switching. The non-uniform hardware delay due to the camera switch can also create problems in implementation. Therefore, if cameras are switched for different shake angles, it can lead to non-uniform video quality, sub-optimal resolution, bad low light performance, switch complications, and hardware delay.

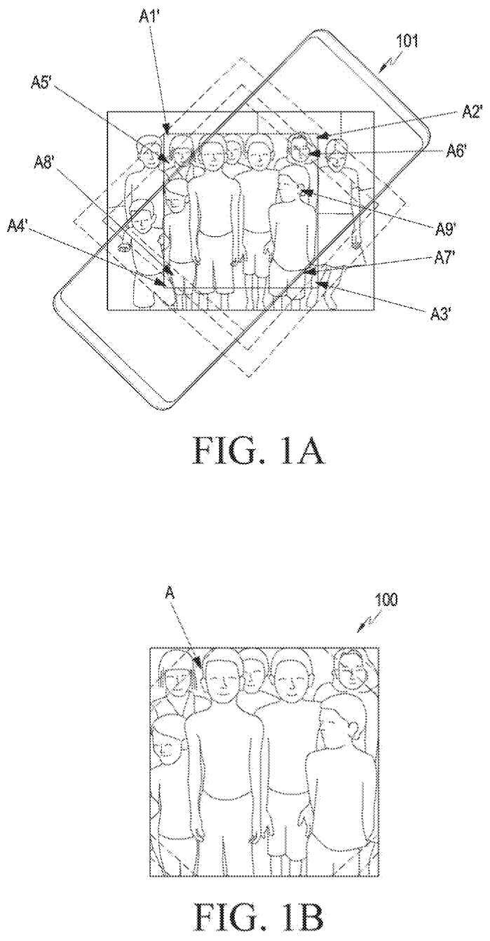

FIG. 1A is a pictorial diagram depicting fragments of a current frame to be extracted according to an embodiment of the present disclosure. FIG. 1B is a pictorial diagram depicting a hyper-stabilized composite video frame 100 having a retention area A including the extracted fragments of the current frame according to an embodiment of the present disclosure. To address the aforementioned problems associated with existing methods, disclosed herein is a system 200 and a method 400 for generating the hyper-stabilized composite video frame 100 as illustrated and explained in the detailed descriptions of FIGS. 1A and 1B. To determine the retention area A, the system 200 is configured to generate the retention area A associated with the current video frame captured by a plurality of the image capturing sensors based on the detected tilt angle, determined field width, a size of the LCSFoV, and a resolution of each image capturing sensor.

Referring to FIG. 1A, A9′ depicts the area of the region captured by an image capturing sensor having the narrowest field of view, the image capturing sensor having the widest field of view, and the image capturing sensor having the wide field of view. This means the area A9′ is captured by all three image capturing sensors of the system 200 implemented in a capturing device 101 having three image capturing sensors. The areas A1′, A2′, A3′, A4′ are only captured by the image capturing sensor having the widest field of view. Finally, the areas A5′, A6′, A7′, A8′ are captured by the image capturing sensors having the widest field of view and the wide field of view. The areas A5′, A6′, A7′, A8′ are not captured by the image capturing sensor having the narrowest field of view. Therefore, the system determines the retention area or the area to be retained as A=A1′+A2′+A3′+A4′+A5′+A6′+A7′+A8′+A9′. According to some embodiments, a term “the retention area” or a term “the area to be retained” may be used to indicate each of A1′ to A9′. The portions of the image or the video frame that fall outside the retention area A are removed from the output image or output video frame. The extracted frame fragments that form part of the retention area A are counter-rotated based on a detected tilt angle (t) and assembled. To assemble the extracted video frame fragments from the current video frame, the system 200 processes the extracted video frame fragments to generate the hyper-stabilized composite video frame 100 and stitches the processed video frame fragments to generate the hyper-stabilized composite video frame 100 as shown in FIG. 1B.

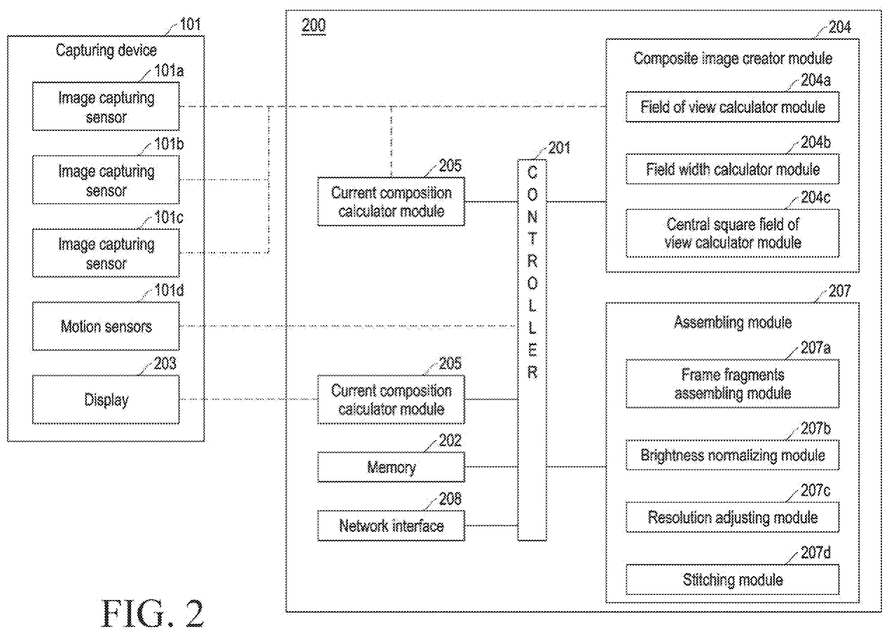

The system 200, shown in FIG. 2 may be implemented in the capturing device 101 associated with a user who desires to initiate the generation of the hyper-stabilized composite video frame 100. Hereinafter, the “capturing device 101” according to various embodiments of the present disclosure includes, for example, a smartphone, a tablet personal computer (PC), a mobile phone, a video phone, and an electronic book reader (e-book reader), desktop PC (desktop personal computer), laptop PC (laptop personal computer), netbook computer, workstation, server, PDA (personal digital assistant), PMP (portable multimedia player), MP3 players, mobile medical devices, cameras or wearable devices (e.g. smart glasses, head-mounted-device (HMD)), electronic clothing, electronic bracelets, electronic necklaces, electronic apps It may include at least one of an accessory, an electronic tattoo, a smart mirror, or a smartwatch.

In some embodiments, the capturing device 101 may be a smart home appliance. Smart appliances include, for example, televisions, digital video disk (DVD) players, audio systems, refrigerators, air conditioners, vacuum cleaners, ovens, microwave ovens, washing machines, air purifiers, set-top boxes, and home automation. Home automation control panel, security control panel, TV box (e.g., Samsung HomeSync™), game console, electronic dictionary, an electronic key, a camcorder, or an electronic picture frame. According to some embodiments, the capturing device 101 may be a piece of furniture or a building/structure, an electronic board, an electronic signature receiving device, a projector, or various measuring instruments (e.g., water supply, electricity, gas, or radio wave measuring devices, etc.). In various embodiments, the capturing device 101 may be a combination of one or more of the various devices described above. The capturing device 101 according to some embodiments may be a flexible electronic device. In addition, the capturing device 101 according to an embodiment of the present disclosure is not limited to the above devices and may include new electronic devices according to technological development.

Hereinafter, the capturing device 101 according to various embodiments will be described with reference to the accompanying drawings. In this document, the term user may refer to a person using an electronic device or a device using an electronic device (e.g., an artificial intelligence electronic device).

FIG. 2 is a block diagram illustrating the system 200 for generating the hyper-stabilized composite video frame 100 associated with the capturing device 101, the system 200 communicably coupled to the capturing device 101 according to an embodiment of the present disclosure as shown in FIGS. 1A-1B.

The system 200 disclosed herein includes at least one controller 201 and a memory 202. The memory 202 is configured to store a corresponding set of parameters associated with each image capturing sensor 101a, 101b, 101c of the capturing device 101. In an embodiment, the corresponding set of parameters includes at least one of the resolution, a focal length, a horizontal size, a vertical size, a horizontal field of view, or a vertical field of view. The at least one controller 201 is communicatively coupled to the memory 202 and configured to receive a current video frame captured by each image capturing sensor 101a, 101b, 101c.

In an embodiment, the system 200, disclosed herein, may be implemented in the capturing device 101 including the at least one controller 201 and the memory 202. As used herein, the “at least one controller 201” is interchangeably referred to as “the controller 201” and may include specialized processing units such as integrated system (bus) controllers, memory management control units, floating point units, graphics processing units, digital signal processing units, etc. In one embodiment, the controller 201 may include a central processing unit (CPU), a graphics processing unit (GPU), or both. The controller 201 may be one or more general processors, digital signal processors, application-specific integrated circuits, field-programmable gate arrays, servers, networks, digital circuits, analog circuits, combinations thereof, or other now-known or later developed devices for analyzing and processing data. The controller 201 may execute one or more instructions, such as code generated manually (i.e., programmed) to perform one or more operations disclosed herein throughout the disclosure.

In an embodiment, the system 200 may be implemented on a cloud-based server. In another embodiment, the system 200 may be implemented in a distributed manner such that one or more of the modules are implemented on the capturing device 101 and one or more of the modules are implemented on the cloud-based server. The modules of the system 200 include a composite image creator module 204, a current composition calculator module 205, an orientation detection module 206, and an assembling module 207. Moreover, the system 200 may optionally include a stitching module 207d.

The memory 202 may include one or more databases to store one or more data and information that may be required to implement the system 200. In an embodiment, the memory 202 stores the corresponding set of parameters for each image capturing sensor 101a, 101b, 101c including, for example, but not limited to the resolution, the focal length, the horizontal size, the vertical size, the horizontal field of view, and the vertical field of view. In an embodiment, the memory 202 may include one or more AI-based trained models that may be deployed on one or more capturing devices 101 for generating the hyper-stabilized composite video frame 100. The system 200 also includes a network interface 208 for providing network connectivity and enabling communication of the capturing device 101 with other capturing devices 101 over a network. The network may include, but is not limited to, a Wide Area Network (WAN), a cellular network, such as a 3G, 4G, or 5G network, an Internet-based mobile ad hoc networks (IMANET), etc. The network may also include wired media such as a wired network or direct-wired connection, and wireless media such as acoustic, radio frequency (RF), microwave, infrared (IR), Bluetooth low energy (BLE) networks, and other wireless media. At least one of the plurality of modules may be implemented through an AI model. A function associated with AI may be performed through the non-volatile memory, the volatile memory, and the controller 201.

In some embodiments, the plurality of modules may be included within the memory 202. The memory 202 may further include a database to store data. The plurality of modules may include a set of instructions that may be executed to cause the system 200, in particular, the controller 201 of the system 200, to perform any one or more of the methods/processes disclosed herein. The plurality of modules may be configured to perform the steps of the present disclosure using the data stored in the database. In an embodiment, each of the plurality of modules may be a hardware unit which may be outside the memory 202. Further, the memory 202 may include an operating system for performing one or more tasks of the system 200, as performed by a generic operating system.

The controller 201 may include one or a plurality of processors. At this time, one or a plurality of processors may be a general purpose processor, such as a central processing unit (CPU), an application processor (AP), or the like, a graphics-only processing unit such as GPU, a visual processing unit (VPU), and/or an AI-dedicated processor such as a neural processing unit (NPU). The one or a plurality of processors control the processing of the input data in accordance with a predefined operating rule or artificial intelligence (AI) model stored in the non-volatile memory and the volatile memory. The predefined operating rule or artificial intelligence model is provided through training or learning.

Here, being provided through learning means that, by applying a learning technique to a plurality of learning data, a predefined operating rule or AI model of a desired characteristic is made. The learning may be performed in a device itself in which AI according to an embodiment is performed, and/or may be implemented through a separate server/system. The AI model may consist of a plurality of neural network layers. Each layer has a plurality of weight values and performs a layer operation through the calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning technique is a method for training a predetermined target device (for example, a robot) using a plurality of learning data to cause, allow, or control the target device to make a determination or prediction. Examples of learning techniques include, but are not limited to, supervised learning, unsupervised learning, semi-supervised learning, or reinforcement learning. According to the disclosure, the method for generating the hyper-stabilized composite video frame 100 may use an artificial intelligence model to recommend/execute the plurality of instructions by using sensor data. The controller 201 may perform a pre-processing operation on the data to convert into a form appropriate for use as an input for the artificial intelligence model. The artificial intelligence model may be obtained by training. Here, “obtained by training” means that a predefined operation rule or artificial intelligence model configured to perform a desired feature (or purpose) is obtained by training a basic artificial intelligence model with multiple pieces of training data by a training technique. The artificial intelligence model may include a plurality of neural network layers. Each of the plurality of neural network layers includes a plurality of weight values and performs neural network computation by computation between a result of computation by a previous layer and the plurality of weight values.

Reasoning prediction is a technique of logical reasoning and predicting by determining information and includes, e.g., knowledge-based reasoning, optimization prediction, preference-based planning, or recommendation. In an embodiment, the capturing device 101 may also include a processor, memory, and a network interface with characteristics like those of the corresponding components coupled to the controller 201. These components are not elaborated upon here to maintain brevity.

The controller 201 may be communicatively coupled with the capturing device 101 associated with a user who desires to initiate the generation of the hyper-stabilized composite video frame 100 on a display or screen 203 of the capturing device 101. In an embodiment, the “display 203” or the “screen 203” may refer to, for example, a liquid crystal display (LCD), a light emitting diode (LED) display, an organic light emitting diode (OLED) display, a micro-electromechanical systems (MEMS) display, or an electronic paper display. The screen 203 may display, for example, various data (e.g., text, image, video, icon, symbols, or a combination of such content) to the user. The display 203 may include a touch screen or sensors that may be configured to receive, for example, a touch, gesture, proximity, or hovering input using an electronic pen or a part of the user's body such that the input indicates an intention of the user to initiate capturing of an image or video frame for generating the hyper-stabilized composite video frame 100.

Upon receiving the input from the user, the controller 201 activates the image capturing sensors 101a, 101b, 101c. In an embodiment, the composite image creator module 204 includes a Field of View (FoV) Calculator module 204a, a field width calculator module 204b, and a Central Square Field of View (CSFoV) Calculator module 204c. Moreover, the controller 201 activates the Field of View (FoV) Calculator module 204a to determine a field of view of each image capturing sensor 101a, 101b, 101c. Although the capturing device 101 is shown as having a three camera system including the three image capturing sensors 101a, 101b, 101c, it may be appreciated that the capturing device 101 may utilize a two camera system, a four camera system, and so on. To calculate the FoV for each image capturing sensor 101a, 101b, 101c, the controller 201 retrieves the corresponding set of parameters for each image capturing sensor 101a, 101b, 101c from the memory 202. The set of parameters include, for example, but are not limited to the resolution, the focal length, the horizontal size, the vertical size, the horizontal field of view, and the vertical field of view. The set of parameters is retrieved and provided as an input to the FoV Calculator module 204a.

In a multi camera capturing device 101, there may be ‘i’ number of image capturing sensors. In the system 200 disclosed herein, the number “i=3” since there are three image capturing sensors 101a, 101b, 101c. The following calculations are derived for the system 200 including “i” number of image capturing sensors. For each image capturing sensor 101a, 101b, 101c, . . . , 101i, the parameters retrieved include:

D_{h,i} Horizontal size of i^{th} image capturing sensor 101i.

D_{v,i}: Vertical size of image capturing sensor 101i.

Fᵢ: Focal length of i^{th} lens of image capturing sensor 101i.

A_{h,i}. Horizontal field of view of i^{th} image capturing sensor 101i in radians.

A_{v,i}: Vertical field of view of i^{th} image capturing sensor 101i in radians.

$${A}_{h , i} = 2 {tan}^{- 1} \frac{{O}_{h , i}}{2 {F}_{i}} \qquad [ Equation 1 ]$$

$${A}_{v , i} = 2 {tan}^{- 1} \frac{{D}_{v , i}}{2 {F}_{i}} \qquad [ Equation 2 ]$$

Thus, we have a FoV=A_{h,i}×A_{v,i} for each image capturing sensor 101a, 101b, 101c, . . . , 101i. The FoV=A_{h,i}×A_{v,i} for each image capturing sensor 101a, 101b, 101c, . . . , 101i is passed as output to the Field Width Calculator module 204b.

The Field Width Calculator module 204b receives the FoV=A_{h,i}×A_{v,i} for each image capturing sensor 101a, 101b, 101c, . . . , 101i as an input from the FoV Calculator Module 204a. The Field Width Calculator module 204b calculates the Field Width size aᵢ for each image capturing sensor 101a, 101b, 101c, . . . , 101i using the equation 3:

$${a}_{i} = min ( {A}_{h , i} , {A}_{v , i} ) \qquad [ Equation 3 ]$$

The determined Field Width size (aᵢ) values for all the image capturing sensors 101a, 101b, 101c, . . . , 101i are sorted from the lowest to the highest and stored in an array. The sorted array is then passed as an output to the CSFoV Calculator Module 204c. The CSFoV Calculator Module 204c calculates the Central Square Field of View (CSFoV) size Si for each image capturing sensor 101a, 101b, 101c, . . . , 101i separately. The CSFoV size Sᵢ is calculated using the equation 4:

$${s}_{i} = \frac{{a}_{i}}{\sqrt{2}} \qquad [ Equation 4 ]$$

Thus, we have a Central Square Field of View Sᵢ×Sᵢ for each image capturing sensor 101a, 101b, 101c, . . . , 101i. The controller 201 selects the Largest Central Square Field of View (LCSFoV) size Sₘ among all the image capturing sensors 101a, 101b, 101c, . . . , 101i. The field of view of the hyper-stabilized composite video frame 100 would be Sₘ×Sₘ This is the optimum hyper-stabilized field of view for the given capturing device 101. The Largest Central Square Field of View (LCSFoV) size Sₘ is passed as output to the current composition calculator module 205.

Simultaneously, the controller 201 activates the orientation detection module 206 of the system 200 to detect the tilt angle of each image capturing sensor 101a, 101b, 101c, . . . , 101i. The controller 201 is configured to receive sensor data generated from at least one motion sensor 101d associated with the capturing device 101 having the image capturing sensors 101a, 101b, 101c, . . . , 101i. The controller 201 of the capturing device 101 is configured to control the motion sensors 101d, either as part of the controller 201 or separately, so that while the controller 201 is in a sleep state, the sensors 101d may be controlled. In an embodiment, the at least one motion sensor 101d includes at least one of a gyroscope or an accelerometer. Optionally, the capturing device 101 may receive sensor data from a plurality of sensors, for example, a gesture sensor, a gyro sensor, an air pressure sensor, a magnetic sensor, an acceleration sensor, a grip sensor, a proximity sensor, color sensor (e.g., RGB (red, green, blue) sensor), bio sensor, temperature/humidity sensor, light sensor, or UV (ultraviolet). In an embodiment, the gyroscope and the accelerometer data is used to accurately determine the tilt angle of the capturing device 101. The determined tilt angle t is passed to the current composition calculator module 205 for calculating correct composition, correcting frame rotation, and extracting frame fragments to generate the hyper-stabilized composite video frame 100.

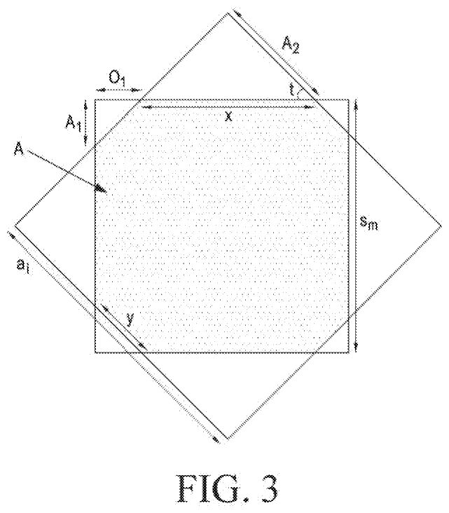

FIG. 3 is a pictorial diagram depicting determination of the retention area A of the current frame according to an embodiment of the present disclosure. The current composition calculator module 205 is configured to receive the detected tilt angle and the corresponding set of parameters associated with each image capturing sensor 101a, 101b, 101c, . . . , 101i to determine the retention area A of the current video frame captured by the plurality of image capturing sensors 101a, 101b, 101c, . . . , 101i. The current composition calculator module 205 receives the sorted Field Width array from the Field Width Calculator module 204b and the LCSFoV) size Sₘ from the CSFoV Calculator module 204c.

FIG. 3 illustrates a scenario in which the retention area A is determined for a single image capturing sensor 101a, or 101b, or 101c, . . . , or 101i. In an embodiment, the CSFoV captured by the wide angle image capturing sensor 101a or 101b or 101c, . . . , 101i is depicted by the square having side aᵢ. For each camera i, the current composition calculator module 205 is configured to calculate the triangular portion Oᵢ×Aᵢ to be cut off from the four corners of the CSFoV for the associated image capturing sensor 101a, or 101b, or 101c, . . . , or 101i. The sides Oᵢ and Aᵢ are calculated using Equations 5 and 6:

$${O}_{i} = \frac{{s}_{m} ( 1 + tan t ) - {a}_{i} sec}{2} \qquad [ Equation 5 ]$$

$${A}_{i} = \frac{{s}_{m} ( 1 + tan t ) - {a}_{i} sec t}{2 tan t} \qquad [ Equation 6 ]$$

Referring to FIG. 3, in an embodiment including the three camera/image capturing sensors capturing a current frame, for a given tilt angle t, an expression for the portion of CSFo V that is taken from the current video frame captured by the wide angle camera is derived. The rest will be captured by the narrow angle camera. In FIG. 3, the size of O₁ and A₁ is determined in radians, given the LCSFoV size Sₘ, the field width of the narrow angle camera aᵢ, and the current rotation angle of the camera t. Then the right angled triangle O₁×A₁ at the four corners of the CSFoV will be taken from the Video/image frame captured by the wide angle camera. The portion of the image captured by the narrow

$${s}_{m} - 2 {A}_{1} , {s}_{m} - 2 {O}_{1} , and \sqrt{{O}_{1}^{2} + {A}_{1}^{2}} .$$

angle camera will be a hexagon with sides

These quantities are in radians. They can be converted into pixels based on the field of view and the resolution of the selected image capturing sensor 101a, 101b, or 101c.

To determine the portion of the CSFoV to be removed from the image capturing sensor 101a/101b/101c with wide field of view, as well as the portion to be removed from the image capturing sensor 101a/101b/101c with the narrow field of view, an expression for 01 and A1 is derived. The remaining portion or the area of the hexagon depicted by A is determined as the retention area A. When the number of image capturing sensors 101a, 101b, 101c are increased, the number of fragmented areas to be removed also increase. Once the video frame fragments corresponding to each image capturing sensor 101a, 101b, 101c, are extracted based on the determined retention area A from the current video frame, the extracted video frame fragments are assembled based on the corresponding set of parameters associated with each image capturing sensor 101a, 101b, 101c. All the lengths necessary for the derivation are indicated in FIG. 3. Then:

$$x = {A}_{2} sec t \qquad [ Equation 7 ]$$

$$y = {A}_{1} sec t \qquad [ Equation 8 ]$$

From the FIG. 3,

$${s}_{m} = x + {A}_{1} + {A}_{1} tan t \qquad [ Equation 9 ]$$

$$∴ {s}_{m} = {A}_{2} sec t + {A}_{1} ( 1 + tan t ) \qquad [ Equation 10 ]$$

$$∴ {A}_{1} = \frac{{s}_{m} - {A}_{2} sec t}{1 + tan t} \qquad [ Equation 11 ]$$

$${a}_{i} = y + {A}_{2} + {A}_{2} tan t \qquad [ Equation 12 ]$$

$$∴ {a}_{i} = {A}_{1} sec t + {A}_{2} ( 1 + tan t ) \qquad [ Equation 13 ]$$

$$∴ {A}_{2} = \frac{{a}_{i} - {A}_{1} sec t}{1 + tan t} \qquad [ Equation 14 ]$$

Substituting the expression for A₂ in A₁, the following is obtained,

$${A}_{1} = \frac{{s}_{m} - ( \frac{{a}_{i} - {A}_{1} sec t}{1 + tan t} ) sec t}{1 + tan t} \qquad [ Equation 15 ]$$

$$Rearranging ,$$

$${{A}_{1} ( 1 + tan t )}^{2} = {s}_{m} ( 1 + tan t ) - a sec t + {A}_{1} {sec}^{2} t \qquad [ Equation 16 ]$$

$$Simplifying ,$$

$${A}_{1} = \frac{{s}_{m} ( 1 + tan t ) - {a}_{i} sec t}{2 tan t} \qquad [ Equation 17 ]$$

$${O}_{1} = \frac{{s}_{m} ( 1 + tan t ) - {a}_{i} sec t}{2} \qquad [ Equation 18 ]$$

Referring to FIG. 2, the assembling module 207 includes a frame fragments assembling module 207a, a brightness normalizing module 207b, a resolution adjusting module 207c, and optionally the stitching module 207d. The frame fragments assembling module 207a receives the input from the orientation detection module 206, the current composition calculator module 205, the CSFoV Calculator module 204c, and the field width calculator module 204b. The input includes the extracted fragments of the video frame, a set of parameters for each image capturing sensor 101a, 101b, 101c, . . . , 101i, 0× A for each image capturing sensor 101a, 101b, 101c, . . . , 101i, detected tilt angle (t), FoV array, Largest Central Square Field of View (LCSFoV) Size, etc.

The frame fragments assembling module 207a counter-rotates each camera frame by the current tilt angle t. For example, in a three camera capturing device 101, the frame fragments assembling module 207a extracts a central hexagon with sides

$${s}_{m} - 2 {A}_{1} , {s}_{m} - {20}_{1} , and \sqrt{{O}_{1}^{2} + {A}_{1}^{2}}$$

from the narrow field image capturing sensor. Thereafter, the right angled triangular regions of size O_{w-1}×A_{w-1} are extracted from the corners of the LCSFoV of the ultra-wide field image capturing sensor. From the wide field image capturing sensor, the frame fragments assembling module 207a extracts a trapezium from each corner having sides

$$\vert {O}_{i} - {O}_{i + 1} \vert , \vert {A}_{i} - {A}_{i + 1} \vert , \sqrt{{O}_{i}^{2} + {A}_{i}^{2}} , \sqrt{{O}_{i + 1}^{2} + {A}_{i + 1}^{2}} .$$

All these quantities are in radians. They can be converted into pixels based on the field of view and resolution of the selected image capturing sensor 101a, or 101b or 101c, . . . , or 101i. The video frame fragments extracted from all the image capturing sensors 101a, 101b, 101c, . . . , 101i are generated as an output and received as an input by the brightness normalizing module 207b. To process the extracted video frame fragments, the controller 201 is configured to determine a brightness factor for each image capturing sensor 101a, 101b, 101c, . . . , 101i based on the determined field width and the received set of parameters associated with each image capturing sensor 101a, 101b, 101c, . . . , 101i. Next, the controller 201 determines a target brightness factor by comparing the determined brightness factors of each image capturing sensor 101a, 101b, 101c, . . . , 101i. For each image capturing sensor 101a, 101b, 101c, . . . , 101i the brightness factor Bᵢ is calculated based on the field width aᵢ and the resolution Rᵢ in the direction of the field width.

$${B}_{i} = \frac{{a}_{i}}{{R}_{i}} \qquad [ Equation 19 ]$$

Consider the central hexagonal image fragment from the image capturing sensor 101a or 101b or 101c, . . . or 101i with the narrowest field of view (for example image capturing sensor 101a) as having the target brightness. For remaining image capturing sensors 101b, 101c, . . . , 101i, brighten the image fragment with the ratio rᵢ.

$${r}_{i} = \frac{{B}_{1}}{{B}_{i}} \qquad [ Equation 20 ]$$

The brightness of each of the extracted video frame fragments is adjusted based on the determined brightness factor. The brightness adjusted video fragments are output to the resolution adjusting module 207c.

The resolution adjusting module 207c adjusts the resolution of each of the video frame fragments based on the received set of parameters associated with each image capturing sensor 101a, 101b, 101c, . . . , 101i. In an embodiment, the resolution of each of the video frame fragments is adjusted using at least one of a super resolution interpolation method or an Enhanced Super-Resolution Generative Adversarial Networks (ESRGAN) based super resolution method. Consider the central hexagonal image fragment from the camera with the narrowest field of view (Camera 1) as having the target resolution. For other cameras i, match the resolution by the super resolution interpolation method or the Enhanced Super-Resolution Generative Adversarial Networks (ESRGAN) based super resolution method.

In the super-resolution by interpolation method, the required number of pixels are added by interpolating between existing pixels. Different interpolation methods like linear, Gaussian, cubic, etc. may be used. This method is faster and near-real-time. On the other hand, the ERSGAN based super-resolution method can be used during post-processing. The output of the brightness normalizing module 207b and the resolution adjusting module 207c includes extracted frame fragments that are processed and adjusted for optimal resolution and brightness. These extracted frame fragments are received as an input by the stitching module 207d. The stitching module 207d is optionally a part of the system 200 or may be implemented as separate from the system 200. The stitching module 207d stitches the processed frame fragments to generate the hyper-stabilized composite video frame 100. The hyper-stabilized composite video frame 100 is then rendered on the display 203 of the capturing device 101. In an embodiment, the hyper-stabilized composite video frame 100 may be shared over a network via the network interface 208 to another capturing device 101 for viewing, sharing, editing, and storing.

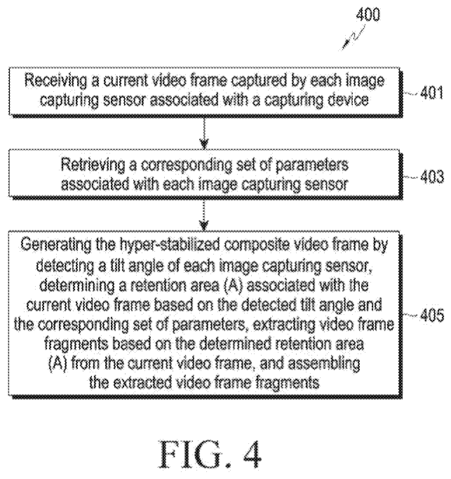

FIG. 4 is a flow diagram depicting a method 400 for generating the hyper-stabilized composite video frame 100, according to an embodiment of the present disclosure. In a multi camera capturing device 101, there may be ‘i’ number of image capturing sensors. In the system 200 disclosed herein, the number “i=3” since there are three image capturing sensors 101a, 101b, 101c. It will be appreciated that although the capturing device 101 includes three image capturing sensors 101a, 101b, and 101c, the system 200 and method 400 is implementable for the capturing device 101 having “i” number of image capturing sensors 101a, 101b, 101c, . . . , 101i.

At Step 401, the method 400 includes receiving by the controller 201 a current video frame captured by each image capturing sensor 101a, 101b, 101c associated with the capturing device 101.

At Step 403, the method 400 includes retrieving by the controller 201 a corresponding set of parameters associated with each image capturing sensor 101a, 101b, 101c. In an embodiment, the corresponding set of parameters comprises at least one of the resolution, a focal length, a horizontal size, a vertical size, a horizontal field of view, or a vertical field of view.

At Step 405, the method 400 includes generating by the controller 201 the hyper-stabilized composite video frame 100. For generating the hyper-stabilized composite video frame 100, the controller 201 first detects a tilt angle of each image capturing sensor 101a, 101b, 101c. In an embodiment, detecting the tilt angle of each image capturing sensor 101a, 101b, 101c includes receiving sensor data generated from the at least one motion sensor 101d associated with the capturing device 101 having the image capturing sensors 101a, 101b, 101c. The at least one motion sensor 101d includes at least one of the gyroscope or the accelerometer. Finally, the tilt angle is detected based on the received sensor data.

In an embodiment, determining the size of the LCSFoV includes determining a size of a Central Square Field of View (CSFoV) for each image capturing sensor based on the determined field widths. Next, the determined sizes of the CSFoV of each image capturing sensor 101a, 101b, 101c are compared. Finally, the size of LCSFoV. is determined based on a result of the comparison.

Next, the controller 201 determines the retention area A associated with the current video frame captured by the plurality of the image capturing sensors 101a, 101b, 101c based on the detected tilt angle and the corresponding set of parameters associated with each image capturing sensor 101a, 101b, 101c. In an embodiment, determining the retention area includes, firstly, determining, for each image capturing sensor 101a, 101b, 101c, a field width based on the retrieved corresponding set of parameters. Next, the size of the Largest Central Square Field of View (LCSFoV) for each image capturing sensor 101a, 101b, 101c is determined based on the determined field width of each image capturing sensor 101a, 101b, 101c. Finally, the retention area associated with the current video frame is generated based on the detected tilt angle, determined field width, a size of the LCSFoV, and the resolution of each image capturing sensor 101a, 101b, and 101c.

Thereafter, the controller 201 extracts the video frame fragments corresponding to each image capturing sensor 101a, 101b, 101c based on the determined retention area from the current video frame. In an embodiment, extracting the video frame fragments from the current video frame includes, firstly, removing portions of the current video frame captured by each image capturing sensor 101a, 101b, 101c based on the determined retention area (A) of the current video frame and the resolution of a corresponding image capturing sensor 101a, 101b, 101c. Secondly, extracting the video frame fragments includes generating the video frame fragments from the remaining portions of the current video frame captured by each image capturing sensor 101a, 101b, 101c. Finally, extracting the video frame fragments includes counter-rotating the generated video frame fragments based on the detected tilt angle.

Finally, the controller 201 assembles the extracted video frame fragments based on the corresponding set of parameters associated with each image capturing sensor 101a, 101b, 101c. In an embodiment, assembling the extracted video frame fragments from the current video frame includes, firstly, processing the extracted video frame fragments to generate the hyper-stabilized composite video frame 100 and stitching the processed video frame fragments to generate the hyper-stabilized composite video frame 100.

Finally, processing the extracted video frame fragments includes determining a brightness factor for each image capturing sensor 101a, 101b, 101c based on the determined field width and the received set of parameters. In an embodiment, the target brightness factor is determined by comparing the determined brightness factors of each image capturing sensor 101a, 101b, 101c. Next, the brightness of each of the extracted video frame fragments is adjusted based on the determined brightness factor and a resolution of each of the video frame fragments is adjusted based on the received set of parameters. In an embodiment, the resolution of each of the video frame fragments is adjusted using at least one of a super resolution interpolation method or an Enhanced Super-Resolution Generative Adversarial Networks (ESRGAN) based super resolution method.

The system 200 and method 400 for generating the hyper-stabilized composite video frame 100 achieves real-time hyper-stabilization (near complete stabilization) of camera rolling shake and can work for both image and video hyper-stabilization. Moreover, the implementation of the system 200 in the capturing device 101 ensures optimal field of view, optimal video resolution, and optimal low light performance. Since a square field of view is chosen for capturing videos, optimal usage of sensor space in all orientations is ensured. Advantageously, the system 200 avoids the use of complex hardware, stabilization mechanisms, or moving components, aging, or failure due to fatigue/malfunctioning of hardware is eliminated. When shaking or tilting of the capturing device 101 causes some video frame portions to go outside the field of view of the capturing device 101, the missing portions are filled in by image capturing sensors 101a, 101b, 101c with larger field of view to create the hyper-stabilized composite video frame 100. Moreover, the system 200 and the method 400 disclosed herein includes super-resolution and brightness normalization to process the video frame based on the portions of the video frame having the highest resolution and the optimal brightness factor. Therefore, video quality is uniform for all shake angles due to implementation of super-resolution. Since all the image capturing sensors 101a, 101b, 101c work all the time, complexities due to switching between image capturing sensors 101a, 101b, 101c while capturing videos is eliminated thereby completely reducing the possibility of hardware delays due to switching. Furthermore, video resolution and low light performance is maintained for large shake angles as well.

Action cameras with multiple parallel sensors capture videos in fast paced, dynamic, and action heavy environments. As a result, action cameras are prone to heavy camera shakes thereby generating low resolution or blurry videos. Since stabilization is crucially important for action cameras, the system 200 implemented in such action cameras provide a solution generating videos with optimal hyper-stabilization and optimal resolution. Similarly, stereo cameras contain multiple parallel image capturing sensors, smartphones including multiple image capturing sensors can advantageously implement the system 200 disclosed herein to achieve hyper-stabilization with optimal resolution.

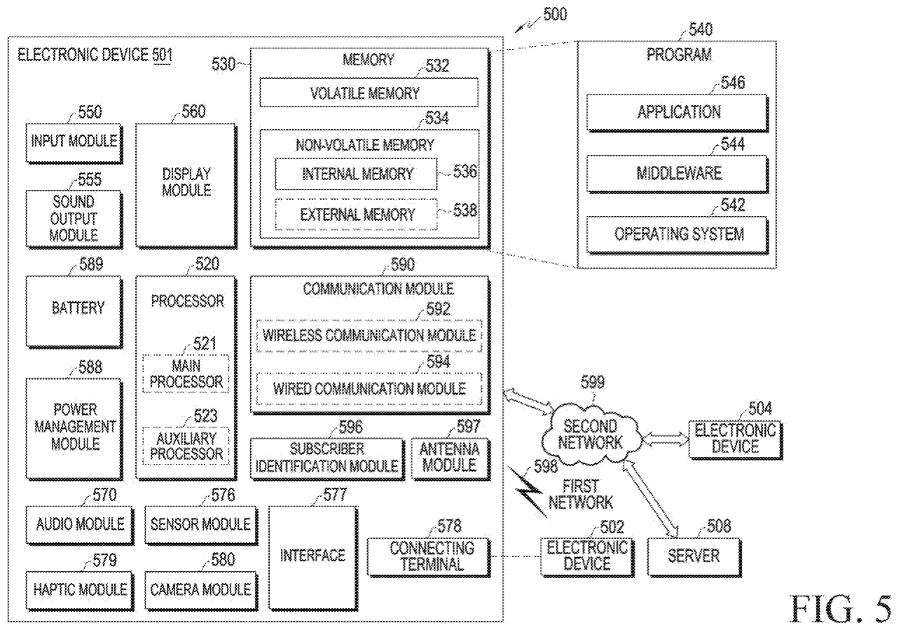

FIG. 5 is a block diagram illustrating an electronic device 501 in a network environment 500 according to various embodiments. Referring to FIG. 5, the electronic device 501 (e.g., the capturing device 101 and/or the system 200) in the network environment 500 may communicate with an electronic device 502 via a first network 598 (e.g., a short-range wireless communication network), or at least one of an electronic device 504 or a server 508 via a second network 599 (e.g., a long-range wireless communication network). According to an embodiment, the electronic device 501 may include the capturing device 101 and/or the system 200. According to an embodiment, the electronic device 501 may communicate with the electronic device 504 via the server 508. According to an embodiment, the electronic device 501 may include a processor 520, memory 530, an input module 550, a sound output module 555, a display module 560, an audio module 570, a sensor module 576, an interface 577, a connecting terminal 578, a haptic module 579, a camera module 580, a power management module 588, a battery 589, a communication module 590, a subscriber identification module (SIM) 596, or an antenna module 597. In some embodiments, at least one of the components (e.g., the connecting terminal 578) may be omitted from the electronic device 501, or one or more other components may be added in the electronic device 501. In some embodiments, some of the components (e.g., the sensor module 576, the camera module 580, or the antenna module 597) may be implemented as a single component (e.g., the display module 560).

The processor 520 may execute, for example, software (e.g., a program 540) to control at least one other component (e.g., a hardware or software component) of the electronic device 501 coupled with the processor 520, and may perform various data processing or computation. According to one embodiment, as at least part of the data processing or computation, the processor 520 may store a command or data received from another component (e.g., the sensor module 576 or the communication module 590) in volatile memory 532, process the command or the data stored in the volatile memory 532, and store resulting data in non-volatile memory 534. According to an embodiment, the processor 520 may include a main processor 521 (e.g., a central processing unit (CPU) or an application processor (AP)), or an auxiliary processor 523 (e.g., a graphics processing unit (GPU), a neural processing unit (NPU), an image signal processor (ISP), a sensor hub processor, or a communication processor (CP)) that is operable independently from, or in conjunction with, the main processor 521. For example, when the electronic device 501 includes the main processor 521 and the auxiliary processor 523, the auxiliary processor 523 may be adapted to consume less power than the main processor 521, or to be specific to a specified function. The auxiliary processor 523 may be implemented as separate from, or as part of the main processor 521.

The auxiliary processor 523 may control at least some of functions or states related to at least one component (e.g., the display module 560, the sensor module 576, or the communication module 590) among the components of the electronic device 501, instead of the main processor 521 while the main processor 521 is in an inactive (e.g., sleep) state, or together with the main processor 521 while the main processor 521 is in an active state (e.g., executing an application). According to an embodiment, the auxiliary processor 523 (e.g., an image signal processor or a communication processor) may be implemented as part of another component (e.g., the camera module 580 or the communication module 590) functionally related to the auxiliary processor 523. According to an embodiment, the auxiliary processor 523 (e.g., the neural processing unit) may include a hardware structure specified for artificial intelligence model processing. An artificial intelligence model may be generated by machine learning. Such learning may be performed, e.g., by the electronic device 501 where the artificial intelligence is performed or via a separate server (e.g., the server 508). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 530 may store various data used by at least one component (e.g., the processor 520 or the sensor module 576) of the electronic device 501. The various data may include, for example, software (e.g., the program 540) and input data or output data for a command related thererto. The memory 530 may include the volatile memory 532 or the non-volatile memory 534.

The program 540 may be stored in the memory 530 as software, and may include, for example, an operating system (OS) 542, middleware 544, or an application 546.

The input module 550 may receive a command or data to be used by another component (e.g., the processor 520) of the electronic device 501, from the outside (e.g., a user) of the electronic device 501. The input module 550 may include, for example, a microphone, a mouse, a keyboard, a key (e.g., a button), or a digital pen (e.g., a stylus pen).

The sound output module 555 may output sound signals to the outside of the electronic device 501. The sound output module 555 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 560 may visually provide information to the outside (e.g., a user) of the electronic device 501. The display module 560 may include, for example, a display, a hologram device, or a projector and control circuitry to control a corresponding one of the display, hologram device, and projector. According to an embodiment, the display module 560 may include a touch sensor adapted to detect a touch, or a pressure sensor adapted to measure the intensity of force incurred by the touch.

The audio module 570 may convert a sound into an electrical signal and vice versa. According to an embodiment, the audio module 570 may obtain the sound via the input module 550, or output the sound via the sound output module 555 or a headphone of an external electronic device (e.g., an electronic device 502) directly (e.g., wiredly) or wirelessly coupled with the electronic device 501.

The sensor module 576 may detect an operational state (e.g., power or temperature) of the electronic device 501 or an environmental state (e.g., a state of a user) external to the electronic device 501, and then generate an electrical signal or data value corresponding to the detected state. According to an embodiment, the sensor module 576 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 577 may support one or more specified protocols to be used for the electronic device 501 to be coupled with the external electronic device (e.g., the electronic device 502) directly (e.g., wiredly) or wirelessly. According to an embodiment, the interface 577 may include, for example, a high definition multimedia interface (HDMI), a universal serial bus (USB) interface, a secure digital (SD) card interface, or an audio interface.

A connecting terminal 578 may include a connector via which the electronic device 501 may be physically connected with the external electronic device (e.g., the electronic device 502). According to an embodiment, the connecting terminal 578 may include, for example, a HDMI connector, a USB connector, a SD card connector, or an audio connector (e.g., a headphone connector).

The haptic module 579 may convert an electrical signal into a mechanical stimulus (e.g., a vibration or a movement) or electrical stimulus which may be recognized by a user via his tactile sensation or kinesthetic sensation. According to an embodiment, the haptic module 579 may include, for example, a motor, a piezoelectric element, or an electric stimulator.

The camera module 580 may capture a still image or moving images. According to an embodiment, the camera module 580 may include one or more lenses, image sensors, image signal processors, or flashes.

The power management module 588 may manage power supplied to the electronic device 501. According to one embodiment, the power management module 588 may be implemented as at least part of, for example, a power management integrated circuit (PMIC).

The battery 589 may supply power to at least one component of the electronic device 501. According to an embodiment, the battery 589 may include, for example, a primary cell which is not rechargeable, a secondary cell which is rechargeable, or a fuel cell.

The communication module 590 may support establishing a direct (e.g., wired) communication channel or a wireless communication channel between the electronic device 501 and the external electronic device (e.g., the electronic device 502, the electronic device 504, or the server 508) and performing communication via the established communication channel. The communication module 590 may include one or more communication processors that are operable independently from the processor 520 (e.g., the application processor (AP)) and supports a direct (e.g., wired) communication or a wireless communication. According to an embodiment, the communication module 590 may include a wireless communication module 592 (e.g., a cellular communication module, a short-range wireless communication module, or a global navigation satellite system (GNSS) communication module) or a wired communication module 594 (e.g., a local area network (LAN) communication module or a power line communication (PLC) module). A corresponding one of these communication modules may communicate with the external electronic device via the first network 598 (e.g., a short-range communication network, such as Bluetooth™, wireless-fidelity (Wi-Fi) direct, or infrared data association (IrDA)) or the second network 599 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 592 may identify and authenticate the electronic device 501 in a communication network, such as the first network 598 or the second network 599, using subscriber information (e.g., international mobile subscriber identity (IMSI)) stored in the subscriber identification module 596.

The wireless communication module 592 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 592 may support a high-frequency band (e.g., the mmWave band) to achieve, e.g., a high data transmission rate. The wireless communication module 592 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 592 may support various requirements specified in the electronic device 501, an external electronic device (e.g., the electronic device 504), or a network system (e.g., the second network 599). According to an embodiment, the wireless communication module 592 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 597 may transmit or receive a signal or power to or from the outside (e.g., the external electronic device) of the electronic device 501. According to an embodiment, the antenna module 597 may include an antenna including a radiating element composed of a conductive material or a conductive pattern formed in or on a substrate (e.g., a printed circuit board (PCB)). According to an embodiment, the antenna module 597 may include a plurality of antennas (e.g., array antennas). In such a case, at least one antenna appropriate for a communication scheme used in the communication network, such as the first network 598 or the second network 599, may be selected, for example, by the communication module 590 (e.g., the wireless communication module 592) from the plurality of antennas. The signal or the power may then be transmitted or received between the communication module 590 and the external electronic device via the selected at least one antenna. According to an embodiment, another component (e.g., a radio frequency integrated circuit (RFIC)) other than the radiating element may be additionally formed as part of the antenna module 597.

According to various embodiments, the antenna module 597 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 501 and the external electronic device 504 via the server 508 coupled with the second network 599. Each of the electronic devices 502 or 504 may be a device of a same type as, or a different type, from the electronic device 501. According to an embodiment, all or some of operations to be executed at the electronic device 501 may be executed at one or more of the external electronic devices 502, 504, or 508. For example, if the electronic device 501 should perform a function or a service automatically, or in response to a request from a user or another device, the electronic device 501, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 501. The electronic device 501 may provide the outcome, with or without further processing of the outcome, as at least part of a reply to the request. To that end, a cloud computing, distributed computing, mobile edge computing (MEC), or client-server computing technology may be used, for example. The electronic device 501 may provide ultra low-latency services using, e.g., distributed computing or mobile edge computing. In another embodiment, the external electronic device 504 may include an internet-of-things (IoT) device. The server 508 may be an intelligent server using machine learning and/or a neural network. According to an embodiment, the external electronic device 504 or the server 508 may be included in the second network 599. The electronic device 501 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 540) including one or more instructions that are stored in a storage medium (e.g., internal memory 536 or external memory 538) that is readable by a machine (e.g., the electronic device 501). For example, a processor (e.g., the processor 520) of the machine (e.g., the electronic device 501) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While specific language has been used to describe the present subject matter, any limitations arising on account thereto, are not intended. As will be apparent to a person in the art, various working modifications may be made to the method in order to implement the present disclosure as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

What is claimed is:

1. A method generating a hyper-stabilized composite video frame, the method comprising:
obtaining a plurality of video frames captured by each camera of a plurality of cameras of an electronic device;
detecting field widths of the plurality of cameras and tilt angles of the plurality of cameras;
based on the field widths and the tilt angles, determining a plurality of largest central square field of views (LCSFoVs) of the plurality of cameras;
based on the plurality of LCSFoVs, determining a retention area with respect to the plurality of video frames;
based on the retention area with respect to the plurality of video frames, identifying, in the plurality of video frames, a plurality of video frame fragments corresponding to the retention area;
assembling the plurality of video frame fragments to generate a hyper-stabilized composite video frame, and
displaying the hyper-stabilized composite video frame via a display of the electronic device.

2. The method of claim 1, wherein the detecting the field widths of the plurality of cameras comprises:
retrieving a corresponding set of parameters associated with each camera of the plurality of cameras; and
determining the field width of each camera of the plurality of cameras based on the corresponding set of parameters associated with the camera,
wherein the determining the plurality of LCSFoVs comprises determining a size of the LCSFoV of each camera of the plurality of cameras based on the field width of the camera, and
wherein the determining the retention area comprises generating the retention area associated with the plurality of video frames captured by the plurality of cameras, based on the tilt angle, the field width, the size of the LCSFoV, and a resolution of each camera of the plurality of cameras.

3. The method of claim 2, wherein the corresponding set of parameters comprises at least one of the resolution, a focal length, a horizontal size, a vertical size, a horizontal field of view, or a vertical field of view.

4. The method of claim 1, wherein the detecting the tilt angles of the plurality of cameras comprises:
receiving sensor data generated from at least one motion sensor of the electronic device, wherein the at least one motion sensor comprises at least one of a gyroscope or an accelerometer, and
detecting the tilt angles based on the sensor data.

5. The method of claim 2, wherein the determining a size of the LCSFoV for each camera of the plurality of cameras:
determining a size of a Central Square Field of View (CSFoV) of each camera of the plurality of cameras based on the field width of the camera;
comparing the sizes of the CSFoVs of the plurality of cameras, and
determining the size of LCSFoV of each camera of the plurality of cameras based on a result of the comparing.

6. The method of claim 2, wherein the assembling the plurality of video frame fragments to generate the hyper-stabilized composite video frame comprises:
removing portions of the plurality of video frames based on the retention area and the resolution of each camera of the plurality of cameras;
generating the plurality of video frame fragments from remaining portions of the plurality of video frames, and
counter-rotating the plurality of video frame fragments based on the tilt angles.

7. The method of claim 2, wherein the assembling the plurality of video frame fragments to generate the hyper-stabilized composite video frame comprises:
processing the plurality of video frame fragments, and
stitching the plurality of processed video frame fragments to generate the hyper-stabilized composite video frame.

8. The method of claim 7, wherein the processing the plurality of video frame fragments comprises:
determining brightness factors for the plurality of cameras based on the field widths and the set of parameters;
determining a target brightness factor by comparing the brightness factors of the plurality of cameras;
adjusting a brightness of each of plurality of the video frame fragments based on the target brightness factor; and
adjusting a resolution of each of the plurality of video frame fragments based on the set of parameters.

9. The method of claim 8, wherein the resolution of each of the plurality of video frame fragments is adjusted using at least one of a super resolution interpolation method or an Enhanced Super-Resolution Generative Adversarial Networks (ESRGAN) based super resolution method.

10. An electronic device comprising:
a plurality of cameras;
at least one processor;
a display; and
memory storing instructions,
wherein the instructions, when executed by the at least one processor individually or collectively, cause the electronic device to:
obtain a plurality of video frames captured by each camera of the plurality of cameras;
detect field widths of the plurality of cameras and tilt angles of the plurality of cameras;
based on the field widths and the tilt angles, determine a plurality of largest central square field of views (LCSFoVs) of the plurality of cameras;
based on the plurality of LCSFoVs, determine a retention area with respect to the plurality of video frames;
based on the retention area with respect to the plurality of video frames, identifying, in the plurality of video frames, a plurality of video frame fragments corresponding to the retention area;
assemble the plurality of video frame fragments to generate a hyper-stabilized composite video frame, and
display the hyper-stabilized composite video frame via the display.

11. The electronic device of claim 10, wherein the instructions, when executed by the at least one processor individually or collectively, cause the electronic device to:
retrieve a corresponding set of parameters associated with each camera of the plurality of cameras; and
determine the field width of each camera of the plurality of cameras based on the corresponding set of parameters associated with the camera,
determine a size of the LCSFoV of each camera of the plurality of cameras based on the field width of the camera, and
generate the retention area associated with the plurality of video frames captured by the plurality of cameras, based on the tilt angle, the field width, the size of the LCSFoV, and a resolution of each camera of the plurality of cameras.

12. The electronic device of claim 11, wherein the corresponding set of parameters comprises at least one of the resolution, a focal length, a horizontal size, a vertical size, a horizontal field of view, or a vertical field of view.

13. The electronic device of claim 10, further comprising at least one motion sensor, wherein the at least one motion sensor comprises at least one of a gyroscope or an accelerometer, and
wherein the instructions, when executed by the at least one processor individually or collectively, cause the electronic device to:
receive sensor data generated from the at least one motion sensor, and
detect the tilt angles based on the sensor data.

14. The electronic device of claim 11, wherein the instructions, when executed by the at least one processor individually or collectively, cause the electronic device to:
determine a size of a Central Square Field of View (CSFoV) of each camera of the plurality of cameras based on the field width of the camera;
compare the sizes of the CSFoVs of the plurality of cameras, and
determine the size of LCSFoV of each camera of the plurality of cameras based on a result of the comparison.

15. The electronic device of claim 11, wherein the instructions, when executed by the at least one processor individually or collectively, cause the electronic device to:
remove portions of the plurality of video frames based on the retention area and the resolution of each camera of the plurality of cameras;
generate the plurality of video frame fragments from remaining portions of the plurality of video frames, and
counter-rotate the plurality of video frame fragments based on the tilt angles.

16. The electronic device of claim 11, wherein the instructions, when executed by the at least one processor individually or collectively, cause the electronic device to:
process the plurality of video frame fragments, and
stitch the plurality of processed video frame fragments to generate the hyper-stabilized composite video frame.

17. The electronic device of claim 16, wherein the instructions, when executed by the at least one processor individually or collectively, cause the electronic device to:
determine brightness factors for the plurality of cameras based on the field widths and the set of parameters;
determine a target brightness factor by comparing the brightness factors of the plurality of cameras;
adjust a brightness of each of plurality of the video frame fragments based on the target brightness factor; and
adjust a resolution of each of the plurality of video frame fragments based on the set of parameters.

18. The electronic device of claim 17, wherein the resolution of each of the plurality of video frame fragments is adjusted using at least one of a super resolution interpolation method or an Enhanced Super-Resolution Generative Adversarial Networks (ESRGAN) based super resolution method.

19. A non-transitory computer-readable storage medium storing one or more programs comprising computer-executable instructions that, when executed by at least one processor of an electronic device, cause the electronic device to:
obtain a plurality of video frames captured by each camera of a plurality of cameras of the electronic device;
detect field widths of the plurality of cameras and tilt angles of the plurality of cameras;
based on the field widths and the tilt angles, determine a plurality of largest central square field of views (LCSFoVs) of the plurality of cameras;
based on the plurality of LCSFoVs, determine a retention area with respect to the plurality of video frames;
based on the retention area with respect to the plurality of video frames, identifying, in the plurality of video frames, a plurality of video frame fragments corresponding to the retention area;
assemble the plurality of video frame fragments to generate a hyper-stabilized composite video frame, and
display the hyper-stabilized composite video frame via a display of the electronic device.
